(19) United States
(12) Patent Application Publication
(10) Pub. No.: US 2008/0208767 A1
(43) Pub. Date: Aug. 28, 2008

(54) Predicting the Performance of Algorithmic Investment Strategies

(76) Inventor: John Murray, Princeton, NJ (US)

Correspondence Address: DEMONT & BREYER, LLC, 100 COMMONS WAY, Ste. 250, HOLMDEL, NJ, 07733, US

(21) Appl. No.: 12/025,843

(22) Filed: Feb. 5, 2008

Related U.S. Application Data
(60) Provisional application No. 60/891,703, filed on Feb. 26, 2007.
(60) Provisional application No. 60/915,801, filed on May 3, 2007.
(60) Provisional application No. 60/944,703, filed on Jun. 18, 2007.

(51) Int. Cl. G06Q 40/00

(52) U.S. Cl. 705/36 R

(57) ABSTRACT

A new type of financial forecasting model, which permits investment returns (as well as other portfolio characteristics) to be forecast according to the state of the portfolio is described. For example, the illustrative embodiment prescribes methods for designing and testing such models, and it specifies ways to use the outputs of such models to accomplish portfolio management tasks that were not possible previously.

### CROSS REFERENCE TO RELATED APPLICATIONS

This application incorporates by reference Disclosure Document Deposit, Deposit Number 608044, (Attorney Docket 555-001us), received Oct. 25, 2006, entitled “Method for Optimizing the Design of Complex Processes.”

This application claims the benefit of U.S. Provisional Application Ser. No. 60/891,703, filed Feb. 26, 2007 (Attorney Docket 555-002us), which application is also incorporated by reference.

This application claims the benefit of U.S. Provisional Application Ser. No. 60/915,801, filed May 3, 2007 (Attorney Docket 555-003us), which application is also incorporated by reference.

This application claims the benefit of U.S. Provisional Application Ser. No. 60/944,703, filed Jun. 18, 2007 (Attorney Docket 555-004us), which application is also incorporated by reference.

### FIELD OF THE INVENTION

The present invention relates to finance in general, and, more particularly, to a method of predicting the performance of algorithmic investment strategies.

### BACKGROUND OF THE INVENTION

Though the use of algorithmic investment strategies has grown dramatically in recent years, no prior method exists to forecast their performance accurately. In fact, it is commonly believed that the performance of algorithmic investment strategies is impossible to forecast. This misconception is due to the fact that, as an algorithm buys and sells securities, the composition of the resultant investment portfolio changes continually. Previous attempts to model the performance of algorithmic strategies ignored the changing composition of the portfolio, making it extremely difficult to identify and quantify recurring sources of profits and risk.

Investment managers evaluate algorithmic investment strategies by simulating their performance on historical market data, rather than explicitly forecasting their future performance; however, this approach has significant shortcomings. Historical performance often depends strongly on idiosyncratic events in the market price history, so strategies that work well on past data often perform poorly in practice. Adjusting the parameters of an algorithm's buy and sell rules in order to optimize performance on historical data leads to unrealistically prescient decisions, such as short-selling stocks the day before a market crash. Sophisticated algorithms often have many free parameters, greatly increasing the likelihood of over-fitting to historical data.

Most investment managers have reconciled themselves to the idea that the performance of their strategies cannot be forecast. Those who use algorithmic investment strategies usually limit their choices to algorithms that require only a small number of parameters. Nevertheless, the performance achieved in historical simulations still exceeds expected future performance by an unknown amount.

### SUMMARY OF THE INVENTION

The present invention introduces a new type of financial forecasting model, which permits investment returns (as well as other portfolio characteristics) to be forecast according to the state of the portfolio. For example, the illustrative embodiment prescribes methods for designing and testing such models, and it specifies ways to use the outputs of such models to accomplish portfolio management tasks that were not possible previously.

The illustrative embodiment is also a method for constructing and utilizing statistical models that forecast the performance of algorithmic investment strategies.

The illustrative embodiment improves upon existing methods in several ways. Unlike existing methods, it enables investment managers to make accurate forecasts of the performance of algorithmic investment strategies, even very complex strategies, and incorporate realistic assumptions about market liquidity, funding costs and transaction costs. Furthermore, it provides a method to identify explanatory variables that influence the performance of a given strategy, and it allows the user to propose many possible forecasting models, with any number of free parameters, and objectively identify the best choice.

The resultant forecasting model enables the investment manager to tune or optimize the underlying investment strategy. The model's real-time performance can be monitored statistically to detect structural changes in the market that impact the accuracy of its forecasts. The model outputs can be used in real time by higher-level algorithms that deploy capital opportunistically among a set of investment strategies.

Given an algorithmic investment strategy, the illustrative embodiment simulates the strategy's future performance by specifying the state of the portfolio in each time period and assigning an expected return or a probability distribution of returns for the period, based upon the portfolio state. Returns can be forecast in absolute terms or relative to a performance benchmark.

The portfolio state is defined by whatever variables the candidate forecasting model needs in order to generate a forecast. These could include information about the composition of the portfolio as well as other information such as the recent performance of the stock market, the level of short-term interest rates, or the recent price volatility of specific markets. Depending upon the strategy, the portfolio might best be described in broad terms, such as the number of investments it contains, or in more precise terms, such as the specific investments it contains. As described below, one aspect of this invention is a method to determine which factors should be included in the forecasting model and in the definition of the state of the portfolio, and which factors should be excluded.

A further aspect of this invention is a particular type of state-dependent forecasting model. This type of model estimates the portfolio's exposure to one or more risk factors in each period, based upon the portfolio state in that period. It then estimates how much excess return the portfolio is expected to generate due to each of these risk factors. One specific example is described below, in which the risk factor is the variance of returns.

Once a satisfactory forecasting model has been constructed, it can be used in real time to forecast the near-term performance of the algorithmic strategy. This is done simply by assessing the current state of the portfolio and generating a forecast that corresponds with that state.

### BRIEF DESCRIPTION OF THE DRAWINGS

FIG. 1 depicts a flowchart of the salient tasks associated with the performance of the illustrative embodiment of the present invention.

FIG. 2 depicts a flowchart of the salient tasks associated with the performance of task 103—finding specific values for the parameters A_{B}, A_{S}, B_{B}, and B_{S}.

FIG. 3 depicts a flowchart of the salient tasks associated with the performance of task 204—estimating the performance metric P_{C}=E(A_{B-C}, A_{S-C}, B_{B-C}, B_{S-C}) for the algorithmic investment strategy.

FIG. 4 depicts a flowchart of the salient tasks associated with the performance of task 202—calibrating and comparing candidate forecasting models.

FIG. 5 depicts a flowchart of the salient tasks associated with the performance of task 404—calculating daily profit forecasts using candidate values for forecasting model parameters.

FIG. 6 depicts a flowchart of the salient tasks comprising task 105, in which the accuracy of the forecasting model is monitored.

FIG. 7 depicts a flowchart of the salient tasks comprising task 106, in which the outputs of the forecasting model are used in real time by an investment meta-algorithm that allocates capital tactically among a set of investment strategies.

### DETAILED DESCRIPTION

For the purposes of this disclosure, the following terms and their inflected forms are defined as follows:
An “algorithmic investment strategy” is defined as a process for managing the composition of an investment portfolio according to one or more rules.
A “market” is defined as an exchange for one or more goods, services, land, interests in land, chattels, money, notes, bonds, stocks, securities, derivatives, and choses in action generally, including intangible property.
A “Markov chain” is defined as a series of states in which the conditional probability distribution of the next state is dependent on the present state, and, at most, a finite number of past states.
A “parameter” is defined as:
   i. a scalar, or
   ii. a one-dimensional vector of scalar values, or
   iii. a multi-dimensional vector of scalar values, or
   iv. any combination of i, ii, and iii,
      wherein a scalar can take a value that is an integer, real, imaginary, complex, discrete, character, Boolean, date, time, timestamp, bit, binary, octal, hexadecimal or user-defined data type.
A “state” is defined as:
   i. a scalar, or
   ii. a one-dimensional vector of scalar values, or
   iii. a multi-dimensional vector of scalar values, or
   iv. any combination of i, ii, and iii,
      wherein a scalar can take a value that is an integer, real, imaginary, complex, discrete, character, Boolean, date, time, timestamp, bit, binary, octal, hexadecimal or user-defined data type.

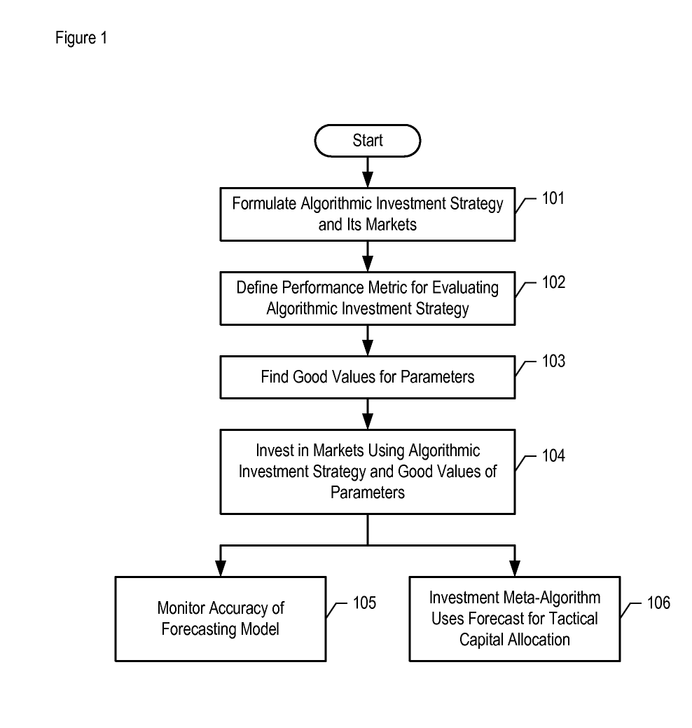

FIG. 1 depicts a flowchart of the salient tasks associated with the performance of the illustrative embodiment of the present invention.

At task 101, the illustrative embodiment formulates an algorithmic investment strategy for one or more markets. It will be clear to those skilled in the art how to accomplish task 101.

Although the illustrative embodiment is an algorithmic investment strategy, it will be clear to those skilled in the art, after reading this disclosure, how to make and use alternative embodiments of the present invention that involve any system that can modeled as a Markov chain. For example, it will be clear to those skilled in the art, after reading this disclosure, how to make and use alternative embodiments of the present invention that relate to other endeavors, such as—for example and without limitation—finance (e.g., credit portfolio construction, derivative portfolio construction, asset and liability management, etc.), condensed matter physics (e.g., supra-molecular chemistry, molecular nanotechnology, synthetic chemistry, etc.), transportation (e.g., aircraft fleet allocation, intelligent transportation systems, navigation under uncertain weather, etc.), queuing (e.g., communications networks, skills-based routing of calls in a call center, etc.), decision theory, sports (e.g., determining advantageous batting orders in baseball, etc.), etc. In accordance with the illustrative embodiment, the Markov chain need not be a perfect representation of the system, but need only be adequate for its intended purpose. It will be clear to those skilled in the art how to determine which systems can and which systems cannot be adequately modeled as a Markov chain.

The algorithmic investment strategy invests in the common stock of two fictional companies: Kimber Computers, Inc. and Victor Computers, Inc. Although the illustrative embodiment invests in two markets, it will be clear to those skilled in the art, after reading this disclosure, how to make and use alternative embodiments of the present invention that invest in any number of markets. Furthermore, although the illustrative embodiment is taught in the context of markets in common stock, it will be clear to those skilled in the art, after reading this disclosure, how to make and use alternative embodiments of the present invention that invest in any markets. And still furthermore, although the illustrative embodiment only takes long positions in a market, it will be clear to those skilled in the art, after reading this disclosure, how to make and use alternative embodiments of the present invention that take:
i. long positions, or
ii. short positions, or
iii. any combination of long and short positions.

In accordance with the illustrative embodiment, the algorithmic investment strategy for investing in Kimber Computers and Victor computers is one variation of the well-known strategy for trading known as the Daily Breakout System. In accordance with the illustrative embodiment, the algorithmic investment strategy for each market is characterized by two rules:
(1) an “entry” rule, and
(2) an “exit” rule.

In accordance with the entry rule, the algorithmic investment strategy buys a long position in the market when the daily closing price of the market is higher than any of its closing prices for the last X trading days, wherein X is a parameter of the algorithmic investment strategy that is restricted to a range. Although the entry rule only comprises one parameter, it will be clear to those skilled in the art, after reading this disclosure, how to make and use alternative embodiments of the present invention in which the entry rule comprises any number of parameters.

In accordance with the exit rule, the algorithmic investment strategy sells a position in the market when the daily closing price of the market is lower than any of its closing prices for the last Y trading days, wherein Y is a parameter of the algorithmic investment strategy that is restricted to a range. Although the exit rule only comprises one parameter, it will be clear to those skilled in the art, after reading this disclosure, how to make and use alternative embodiments of the present invention in which the exit rule comprises any number of parameters.

Furthermore, it will be clear to those skilled in the art, after reading this disclosure, how to make and use alternative embodiments of the present invention in which the algorithmic investment strategy comprises any number of rules (e.g., entry rules, exit rules, hedging rules, volatility rules, position rules, etc.) and any number and kind of parameters.

The entry rule for investing in Kimber Computer is to buy $1 million worth of Kimber Computer common whenever the daily closing price in Kimber Computer exceeds its highest closing price of the last A_{B} days, provided that Kimber Computer is not already owned. In accordance with the illustrative embodiment, A_{B} is an integer in the range of 1≦A_{B}≦252, and its exact value is determined in task 103 below.

The range of A_{B} is a guesstimate of the maximum range of values for A_{B} that can be expected to yield excellent values of the performance metric defined in task 102 below. In general, the choice of the range is based on logic, experience, intuition, and two additional considerations. First, as the range increases, the search space of A_{B} increases. As the search space of A_{B} increases, the computational difficulty of finding a value of A_{B} that yields an excellent value of the performance metric increases. Second, if the upper boundary is too low or the lower boundary is too high, then a value of A_{B} that yields an excellent value of the performance metric might be precluded from consideration.

In the illustrative embodiment, the lower bound is chosen as 1 based on logic, and the upper bound is chosen as 252 because it is equal to the average number of trading days of the New York Stock Exchange. Other values for the upper bound, both smaller and larger than 252 are also reasonable, however. It will be clear to those skilled in the art, after reading this disclosure, how to choose a reasonable range for the parameters for any embodiment of the present invention.

Although the entry rule for Kimber Computer dictates the purchase of $1 million worth of stock, will be clear to those skilled in the art, after reading this disclosure, how to make and use alternative embodiments of the present invention that make any size investment—or that dictate the size of the investment as a function of other factors (e.g., the size of the portfolio, the amount of cash on hand, etc.).

The exit rule for divesting the position in Kimber Computer is to sell the stock whenever the market's daily closing price in Kimber Computer is below its lowest closing price of the last A_{S} days. In accordance with the illustrative embodiment, A_{S} is an integer in the range of 1≦A_{S}≦252, and its exact value is determined in task 103 below. The reasoning underlying the choice of the range of A_{S} mimics the reasoning for the range for A_{B}.

The entry rule for investing in Victor Computer is to buy $1 million worth of Victor Computer common whenever the daily closing price in Victor Computer exceeds its highest closing price of the last B_{B} days, provided that Victor Computer is not already owned. In accordance with the illustrative embodiment, B_{B} is an integer in the range of 1≦B_{B}≦252, and its exact value is determined in task 103 below. The reasoning underlying the choice of the range of B_{B} mimics the reasoning for the range for A_{B}.

The exit rule for divesting the position in Victor Computer is to sell the stock whenever the market's daily closing price in Victor Computer is below its lowest closing price of the last B_{S} days. In accordance with the illustrative embodiment, B_{S} is an integer in the range of 1≦B_{S}≦252, and its exact value is determined in task 103 below. The reasoning underlying the choice of the range of B_{S} mimics the reasoning for the range for A_{B}.

At task 102, the illustrative embodiment defines a performance metric P_{C}=E(w, x, y, z) for evaluating the relative advantageousness of the different sets of values for the parameters A_{B}, A_{S}, B_{B}, and B_{S}. In accordance with the illustrative embodiment, the performance metric is the expected annual return on investment. It will be clear to those skilled in the art, after reading this disclosure, how to make and use alternative embodiments of the present invention in which the performance metric is a probability distribution of annual return on investment. Furthermore, it will be clear to those skilled in the art, after reading this disclosure, how to make and use alternative embodiments of the present invention in which the performance metric is relative to a benchmark (e.g., the S&P 500, the DJIA, a currency index, the federal funds rate, etc.). Moreover, it will be clear to those skilled in the art, after reading this disclosure, how to make and use alternative embodiments of the present invention in which the performance metric is a measure of goodness of fit to a specified quantity or data series (e.g., the historical performance of a hedge fund sector index).

At task 103, the illustrative embodiment finds a specific set of values for the parameters A_{B}, A_{S}, B_{B}, and B_{S}. When the search space of the parameters and the state space of the Markov model that models the algorithmic investment strategy is small enough that the search space can be exhaustively searched, the set of values that generates the best value of the performance metric can be found. Alternatively, when the search space of the parameters or the state space of the Markov model is too large to be exhaustively searched, a set of values that generates a good or desired value of the performance metric might be the best that can be found. To accomplish this, the illustrative embodiment uses a probabilistic meta-algorithm. The specifics of task 103 are described in detail below and in the accompanying drawings. It will be clear, however, to those skilled in the art—after reading this disclosure—how to make and use alternative embodiments of the present invention that use any search strategy to find good values for the parameters.

At task 104, the illustrative embodiment invests, in well-known fashion, in Kimber Computer and Victor Computer using the algorithmic investment strategy formulated in task 101 and the values for the parameters found in task 103.

At task 105, the accuracy of the forecasting model is monitored in real time. The specifics of task 105 are described in detail below and in the accompanying drawings.

At task 106, the outputs of the forecasting model are used in real time by an investment meta-algorithm that allocates capital tactically among a set of investment strategies. The specifics of task 106 are described in detail below and in the accompanying drawings.

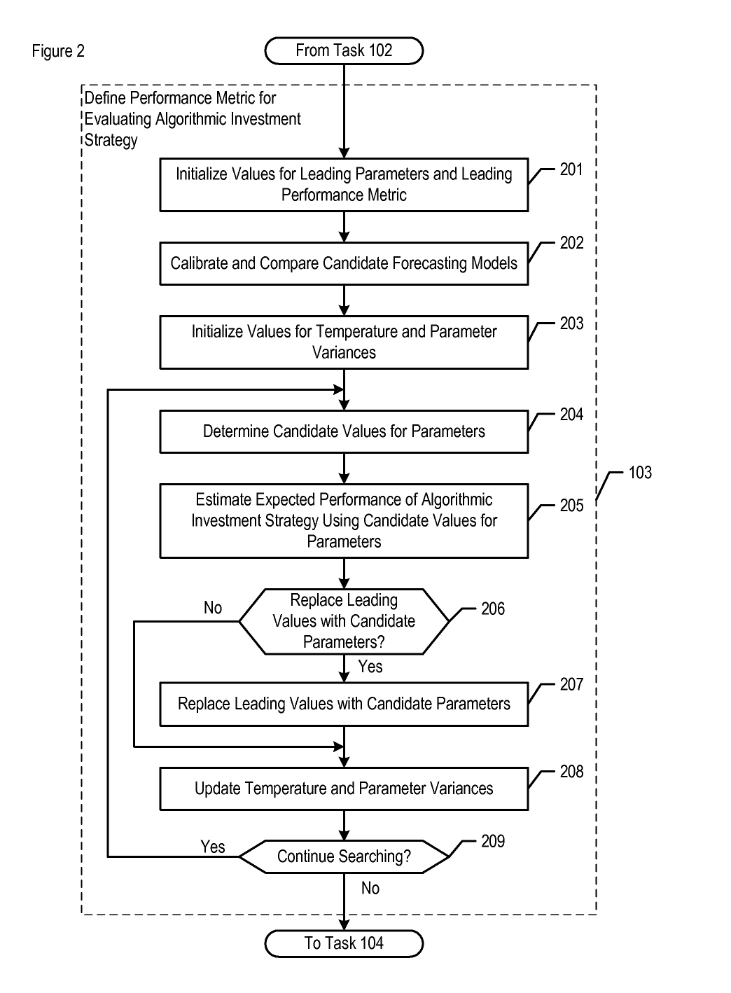

FIG. 2 depicts a flowchart of the salient tasks associated with the performance of task 103—finding specific values for the parameters A_{B}, A_{S}, B_{B}, and B_{S}. In accordance with the illustrative embodiment, task 103 uses the well-known technique known as simulated annealing to find specific values for the parameters A_{B}, A_{S}, B_{B}, and B_{S}. It will be clear to those skilled in the art, however, after reading this disclosure, how to make and use alternative methods (e.g., quantum annealing, stochastic tunneling, tabu search, stochastic hill climbing, genetic algorithms, ant colony optimization, particle-swarm optimization, cross-entropy method, stochastic optimization, etc.) to effect task 103.

At task 201, the illustrative embodiment chooses an initial value for four variables A_{B-L}, A_{S-L}, B_{B-L}, and B_{S-L}. At each instant during task 103, the values of A_{B-L}, A_{S-L}, B_{B-L}, and B_{S-L} represent the leading values for the parameters A_{B}, A_{S}, B_{B}, and B_{S}, respectively, found so far by the illustrative embodiment. At the end of task 103, the values of A_{B-L}, A_{S-L}, B_{B-L}, and B_{S-L} represent the final values for the parameters A_{B}, A_{S}, B_{B}, and B_{S} to be used in task 104.

The range of the variables A_{B-L}, A_{S-L}, B_{B-L}, and B_{S-L} is the same as the range of the parameters A_{B}, A_{S}, B_{B}, and B_{S}, respectively. In accordance with the illustrative embodiment, the initial value for each variable is 126 because it is in the middle of its allowable range. It will be clear to those skilled in the art how to choose initial values for the variables in alternative embodiments of the present invention.

As part of task 201, an initial value for the performance metric P_{L} is chosen that is clearly worse than that which can be achieved by any set of values of the parameters A_{B}, A_{S}, B_{B}, and B_{S}. At the end of task 103, the value of P_{L} represents the expected return on investment of the algorithmic investment strategy using the values of A_{B-L}, A_{S-L}, B_{B-L}, and B_{S-L} for the parameters A_{B}, A_{S}, B_{B}, and B_{S}.

In accordance with the illustrative embodiment, the initial value of the performance metric P_{L} is chosen to be equal to −100, which represents a loss of all of the value in the portfolio. It will be clear to those skilled in the art, after reading this disclosure, how to choose an initial value for the performance metric P_{L} for alternative embodiments of the present invention.

At task 202, the candidate forecasting models are calibrated and compared. This is described in detail below and in the accompanying figures.

At task 203, an initial value for the “temperature” T is chosen, which in accordance with simulated annealing is a parameter that assists the process to converge on advantageous values for the parameters A_{B}, A_{S}, B_{B}, and B_{S}. In accordance with the illustrative embodiment, the initial temperature T is chosen as 15°. It will be clear to those skilled in the art, after reading this disclosure, how to choose an initial temperature T for alternative embodiments of the present invention.

To ensure that the illustrative embodiment is not caught in an infinite loop, a counter M is initialized to the maximum number of times that task 208 is to be executed. In accordance with the illustrative embodiment, M is initialized to 1,000,000,000. The counter M is also used to control the rate at which “cooling” occurs in the simulated annealing process, as is described below in task 208. It will be clear to those skilled in the art how to chose a reasonable value for M for other embodiments of the present invention.

Also as part of task 203, the variance for each of the parameters A_{B}, A_{S}, B_{B}, and B_{S} are chosen. The variance for each parameter is the variance of a uniform probability function having the range of the parameter. In accordance with the illustrative embodiment, the variance for each parameter is given in Table 1.

TABLE 1
Variance of the Parameters A_{B}, A_{S}, B_{B}, and B_{S}

| Parameter | Range | Variance |
|---|---|---|
| A_{B} | 1 to 252 | Var(A_{B}) = 1849 |
| A_{S} | 1 to 252 | Var(A_{S}) = 1849 |
| B_{B} | 1 to 252 | Var(B_{B}) = 1849 |
| B_{S} | 1 to 252 | Var(B_{S}) = 1849 |

At task 204, values for the variables A_{B-C}, A_{S-C}, B_{B-C}, and B_{S-C} are chosen that are candidates to replace the values of the leading variables A_{B-L}, A_{S-L}, B_{B-L}, and B_{S-L}. The criterion used to decide whether the values of the candidate variables replace the values of the leading variables or not is described in detail below with respect to task 207.

In accordance with the illustrative embodiment, the value of A_{B-C} equals:

A_{B-C}=A_{B-L}+R (Eq. 1)

bounded by the allowable range of A_{B}, wherein R is drawn randomly from a user-specified probability distribution (e.g., Gaussian, etc.) centered around zero, having variance var(A_{B}). For example, R is chosen by selecting a random real number between 0 and 1, then finding the number R that corresponds with that point on the cumulative density function of a Gaussian distribution centered at zero, having variance var(A_{B}).

In accordance with the illustrative embodiment, the value of A_{S} equals:

A_{S-C}=A_{S-L}+R (Eq. 2)

bounded by the allowable range of A_{S}, wherein R is also drawn randomly from a user-specified probability distribution centered around zero, having variance var(A_{S}).

In accordance with the illustrative embodiment, the value of B_{B} equals:

B_{B-C}=B_{B-L}+R (Eq. 3)

bounded by the allowable range of B_{B}, wherein R is also drawn randomly from a user-specified probability distribution centered around zero, having variance var(B_{B}).

In accordance with the illustrative embodiment, the value of B_{S} equals:

B_{S-C}=B_{S-L}+R (Eq. 4)

bounded by the allowable range of B_{S}, wherein R is also drawn randomly from a user-specified probability distribution centered around zero, having variance var(B_{S}).

Upon each completion of task 204, the counter M is decremented by 1.

At task 205, the performance metric P_{C}=E(A_{B-C}, A_{S-C}, B_{B-C}, B_{S-C}) is estimated for the algorithmic investment strategy. This is described in detail below and in the accompanying figures.

At task 206, the decision is made whether the values of the candidate variables A_{B-C}, A_{S-C}, B_{B-C}, and B_{S-C} should replace the values of the leading variables A_{B-L}, A_{S-L}, B_{B-L}, and B_{S-L}. In accordance with the illustrative embodiment, there are two tests to determine whether the candidate variables A_{B-C}, A_{S-C}, B_{B-C}, and B_{S-C} should replace the values of the leading variables A_{B-L}, A_{S-L}, B_{B-L}, and B_{S-L}. If the answer to either test is affirmative, then the values of the candidate variables A_{B-C}, A_{S-C}, B_{B-C}, and B_{S-C} should replace the values of the leading variables A_{B-L}, A_{S-L}, B_{B-L}, and B_{S-L} and control passes to task 207. If the answer to both tests is negative, then the values of the leading parameters are not changed and control passes to task 208.

In accordance with the first test, if:

P_{C}>P_{L} (Eq. 5)

then the values of the candidate variables A_{B-C}, A_{S-C}, B_{B-C}, and B_{S-C} should replace the values of the leading variables A_{B-L}, A_{S-L}, B_{B-L}, and B_{S-L} and control passes to task 207.

In accordance with the second test, if:

P_{C}−P_{L}>T·log(R) (Eq. 6)

wherein R is another instance of a real random variable in the range 0<R≦1, then the values of the candidate variables A_{B-C}, A_{S-C}, B_{B-C}, and B_{S-C} should replace the values of the leading variables A_{B-L}, A_{S-L}, B_{B-L}, and B_{S-L} and control passes to task 207.

At task 207, the values of the candidate variables A_{B-C}, A_{S-C}, B_{B-C}, and B_{S-C} replace the values of the leading variables A_{B-L}, A_{S-L}, B_{B-L}, and B_{S-L} and the value of the PC replaces the value of P_{L}, as indicated in equations 7, 8, 9, 10, and 11.

A_{B-L}←A_{B-C} (Eq. 7)

A_{S-L}←A_{S-C} (Eq. 8)

B_{B-L}←B_{B-C} (Eq. 9)

B_{S-L}←B_{S-C} (Eq. 10)

P_{L}←P_{C} (Eq. 11)

At task 208, the values of the temperature T and the variances Var(A_{B}), Var(A_{S}), Var(B_{B}), and Var(B_{S}) are reduced to ensure that the values of A_{B-L}, A_{S-L}, B_{B-L}, and B_{S-L} converge on a good or excellent value of P_{L}. Although there are an infinite number of techniques for determining when and how to reduce the values of the temperature T and the variances, in accordance with the illustrative embodiment, they are reduced in accordance with equations 12, 13, 14, 15, and 16.

$$\begin{matrix}var ( {A}_{B} ) ← var ( {A}_{B} ) \cdot ( \frac{M - 1}{M} ) & ( Eq . 12 ) \\ var ( {A}_{S} ) ← var ( {A}_{S} ) \cdot ( \frac{M - 1}{M} ) & ( Eq . 13 ) \\ var ( {B}_{B} ) ← var ( {B}_{B} ) \cdot ( \frac{M - 1}{M} ) & ( Eq . 14 ) \\ var ( {B}_{S} ) ← var ( {B}_{S} ) \cdot ( \frac{M - 1}{M} ) & ( Eq . 15 ) \\ T ← T \cdot ( \frac{M - 1}{M} ) & ( Eq . 16 )\end{matrix}$$

In accordance with the illustrative embodiment, the counter M is decremented each time that task 208 is executed. It will be clear to those skilled in the art how to make and use alternative embodiments of the present invention that use other methods for reducing the values of the temperature T and the variances Var(A_{B}), Var(A_{S}), Var(B_{B}), and Var(B_{S}).

At task 209, the decision is made whether another set of candidate variables A_{B-C}, A_{S-C}, B_{B-C}, and B_{S-C} should be generated and evaluated. Although there exists an infinite number of possible tests for making this decision, in accordance with the illustrative embodiment of the present invention, M sets of candidate parameter values X_{C}, Y_{C}, and Z_{C} are evaluated, and, therefore, control passes to task 204 while M−1>0; Conversely, control passes to task 104 when M−1=0 sets have been considered.

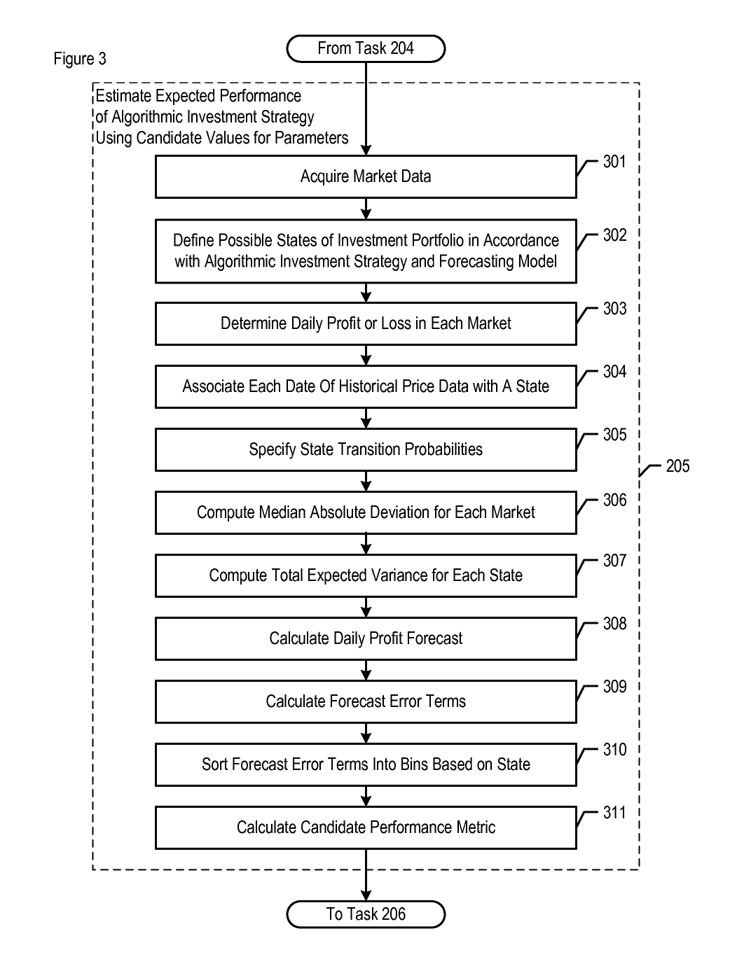

FIG. 3 depicts a flowchart of the salient tasks associated with the performance of task 205—estimating the performance metric P_{C}=E(A_{B-C}, A_{S-C}, B_{B-C}, B_{S-C}) for the algorithmic investment strategy.

At task 301, market data for Kimber Computer and Victor Computer are acquired. For pedagogical purposes the illustrative embodiment uses twenty (20) days worth of daily per share closing prices, as depicted in Table 2, but it will be clear to those skilled in the art how to make and use alternative embodiments of the present invention that use any amount of historical data. The illustrative embodiment uses daily per share closing prices, but it will be clear to those skilled in the art, after reading this disclosure, how to make and use alternative embodiments of the present invention that use other data (e.g., volume data, opening price data, up-tick data, down-tick data, inter-market data, etc.) for any period (e.g., per hour, per minute, per tick, etc.). As will be clear to those skilled in the art, the more historical data that is available and used, the better.

TABLE 2
Twenty Days of Daily per Share Closing Prices

| | Kimber | Victor |
|---|---|---|
| | Computer | Computer |
| | Share | Share |
| | Closing | Closing |
| Day | Price | Price |
| 1 | 91.55 | 21.28 |
| 2 | 93.05 | 22.17 |
| 3 | 93.06 | 22.09 |
| 4 | 92.78 | 22.59 |
| 5 | 93.04 | 23.36 |
| 6 | 91.21 | 23.00 |
| 7 | 91.55 | 23.73 |
| 8 | 89.70 | 24.12 |
| 9 | 90.31 | 24.20 |
| 10 | 94.02 | 22.85 |
| 11 | 95.32 | 22.72 |
| 12 | 97.10 | 22.73 |
| 13 | 97.70 | 22.61 |
| 14 | 97.51 | 22.18 |
| 15 | 97.90 | 22.56 |
| 16 | 99.85 | 23.01 |
| 17 | 98.80 | 23.07 |
| 18 | 97.38 | 22.52 |
| 19 | 98.01 | 22.68 |
| 20 | 99.23 | 22.56 |

At task 302, all of the possible states of the investment portfolio are defined in accordance with the algorithmic investment strategy and the forecasting model. In the illustrative embodiment, because the algorithmic investment strategy can, on any day, have a position in Kimber Computer and Victor Computer and because the timing of those investments is independent, the portfolio can have four possible states as depicted in Table 3. It will be clear to those skilled in the art, after reading this disclosure, how to identify all of the possible states of a portfolio in accordance with any algorithmic investment strategy and forecasting model.

TABLE 3
Possible States of Portfolio in Accordance with
Algorithmic Investment Strategy

| | Kimber | |
|---|---|---|
| | Computer | Victor Computer |
| | Owned in | Owned in |
| State | Portfolio | Portfolio |
| q₀ | No | No |
| q₁ | Yes | No |
| q₂ | No | Yes |
| q₃ | Yes | Yes |

At task 303, the algorithmic investment strategy, with the candidate variables A_{B-C}, A_{S-C}, B_{B-C}, and B_{S-C} is applied to the historical price data in Table 1 to determine (1) at the end of which days there is an investment in each stock, and (2) the daily profit or loss in each stock per million dollars invested. For Kimber Computer, with the values for the candidate variables A_{B-C}=2, A_{S-C}=2, this is depicted in Table 4A.

TABLE 4A
Daily Profit and Loss in Kimber Computer Using Historical Data and
Algorithmic Investment Strategy with A_{B-C} = 2 and A_{S-C} = 2.

| | Kimber | | Daily Profit |
|---|---|---|---|
| | Computer | | (Loss) Per |
| | Share | Invested At End | Million |
| | Closing | Of Day? (A_{B-C} = 2, | Dollars |
| Day | Price | A_{S-C} = 2) | Invested |
| 1 | 91.55 | No | — |
| 2 | 93.05 | No | — |
| 3 | 93.26 | Buy at End of Day | — |
| 4 | 92.78 | Sell at End of Day | (5147) |
| 5 | 93.04 | No | — |
| 6 | 91.21 | No | — |
| 7 | 91.55 | No | — |
| 8 | 89.70 | No | — |
| 9 | 90.31 | No | — |
| 10 | 94.02 | Buy at End of Day | — |
| 11 | 95.32 | Hold | 13,827 |
| 12 | 97.10 | Hold | 18,674 |
| 13 | 97.70 | Hold | 6,179 |
| 14 | 96.51 | Sell at End of Day | (12,180) |
| 15 | 97.90 | Buy at End of Day | — |
| 16 | 99.85 | Hold | 19,918 |
| 17 | 98.80 | Hold | (10,516) |
| 18 | 97.38 | Sell at End of Day | (14,372) |
| 19 | 98.01 | No | — |
| 20 | 99.23 | Buy at End of Day | — |

As can be seen in Table 4A, because the closing share price of Kimber Computer on Day 3 is higher than on any of the previous A_{B-C}=2 days, the entry rule is triggered and shares are purchased at the closing price on Day 3. Because the closing share price on Day 4 is lower than on any of the previous A_{S-C}=2 days, the exit rule is triggered and the shares purchased on Day 3 are sold at the closing price on Day 4. The entry and exit rules are identically applied for the rest of the twenty days of data, which causes the stock to be purchased also on Days 10, 15, and 20 and sold on Days 14 and 18.

In the last column, the daily profit or loss per dollar invested at the beginning of the day—net financing and transaction costs—is calculated for only those days in which the algorithmic investment strategy indicates that an investment is made.

For Victor Computer, with the values for the candidate variables B_{B-C}=2, and B_{S-C}=3, this is depicted in Table 4B.

TABLE 4B
Daily Profit and Loss in Victor Computer Using Historical Data and
Algorithmic Investment Strategy with B_{B-C} = 2 and B_{S-C} = 3.

| | Victor | | Daily Profit |
|---|---|---|---|
| | Computer | | (Loss) Per |
| | Share | Invested At End | Million |
| | Closing | Of Day? (B_{B-C} = 2, | Dollars |
| Day | Price | B_{S-C} = 3) | Invested |
| 1 | 21.28 | No | — |
| 2 | 22.17 | No | — |
| 3 | 22.09 | No | — |
| 4 | 22.59 | Buy at End of Day | — |
| 5 | 23.36 | Hold | 34,086 |
| 6 | 23.00 | Hold | (15,411) |
| 7 | 23.73 | Hold | 31,739 |
| 8 | 24.12 | Hold | 16,435 |
| 9 | 24.20 | Hold | 3,317 |
| 10 | 22.85 | Sell at End of Day | (55,785) |
| 11 | 22.72 | No | — |
| 12 | 22.73 | No | — |
| 13 | 22.61 | No | — |
| 14 | 22.18 | No | — |
| 15 | 22.56 | No | — |
| 16 | 23.01 | Buy at End of Day | — |
| 17 | 23.07 | Hold | 2,608 |
| 18 | 22.52 | Sell at End of Day | (23,840) |
| 19 | 22.68 | No | — |
| 20 | 22.56 | No | — |

As can be seen in Table 4B, because the closing share price of Victor Computer on Day 4 is higher than on any of the previous B_{B-C}=2 days, the entry rule is triggered and shares are purchased at the closing price on Day 4. Because the closing share price on Day 10 is lower than on any of the previous B_{S-C}=3 days, the exit rule is triggered and the shares purchased on Day 4 are sold at the closing price on Day 10. The entry and exit rules are identically applied for the rest of the twenty days of data, which causes the stock to be purchased also on Day 16 and sold on Day 18.

In the last column, the daily profit or loss per dollar invested at the beginning of the day—net financing and transaction costs—is calculated for only those days in which the algorithmic investment strategy indicates that an investment is made.

At task 304, each day of historical data is associated with one of the states enumerated in task 302 based on which investments the algorithmic investment strategy indicated on that day. This is based on the data in Tables 4A and 4B and is depicted in Table 5.

TABLE 5
States of the Investment Portfolio Using Historical
Data and Algorithmic Investment Strategy

| | Investment | Investment | |
|---|---|---|---|
| | in Kimber | in Victor | Portfolio |
| Day | Computer | Computer | State |
| 1 | No | No | q₀ |
| 2 | No | No | q₀ |
| 3 | No | No | q₀ |
| 4 | Yes | No | q₁ |
| 5 | No | Yes | q₂ |
| 6 | No | Yes | q₂ |
| 7 | No | Yes | q₂ |
| 8 | No | Yes | q₂ |
| 9 | No | Yes | q₂ |
| 10 | No | Yes | q₂ |
| 11 | Yes | No | q₁ |
| 12 | Yes | No | q₁ |
| 13 | Yes | No | q₁ |
| 14 | Yes | No | q₁ |
| 15 | No | No | q₀ |
| 16 | Yes | No | q₁ |
| 17 | Yes | Yes | q₃ |
| 18 | Yes | Yes | q₃ |
| 19 | No | No | q₀ |
| 20 | No | No | q₀ |

From Tables 4A and 4B, it can be seen that there is no investment in either Kimber Computer or Victor Computer on Days 1, 2, 3, 15, 19, or 20, and, therefore, the state of the portfolio on those days is q₀. Also it can be seen that there is an investment in Kimber Computer, but not Victor Computer on Days 4, 11, 12, 13, and 14, the state of the portfolio on those days is q₁. Likewise, there is an investment in Victor Computer, but not Kimber Computer on Days 5 through 10, and, therefore, the state of the portfolio on those days is q₂. And finally, there is an investment in both Kimber Computer and Victor Computer on Days 17 and 18, and, therefore, the state of the portfolio on those days is q₃. It will be clear to those skilled in the art, how to associate each period of historical data with a state of the portfolio for any algorithmic investment strategy and any historical data.

At task 305, the state transition probabilities are specified for each pair of states. For the illustrative embodiment, this is depicted in Table 6. So, for example, based on the historical succession of states in Table 5, ⅗^{th}s or 60% of the time that the portfolio is in state q₀, it transits back into state q₀, but ⅖^{th}s or 40% of the time that the portfolio is in state q₀, it transits into state q₁. The state transition probabilities are used as described below.

TABLE 6
State Transition Probabilities Using Historical
Data and Algorithmic Investment Strategy

| | To q₀ | To q₁ | To q₂ | To q₃ |
|---|---|---|---|---|
| From q₀ | ⅗ | ⅖ | 0 | 0 |
| From q₁ | ⅙ | 3/6 | ⅙ | ⅙ |
| From q₂ | ⅙ | 0 | ⅚ | 0 |
| From q₃ | ½ | 0 | 0 | ½ |

It will be clear to those skilled in the art, after reading this disclosure, how to specify the state transition probabilities for each pair of states for any algorithmic investment strategy and any historical data.

At task 306, the median absolute deviation per million dollars invested V is calculated for each stock for only those days in which it was owned (i.e., those days in which the portfolio is in state q₁ or q₃ for Kimber computer and state q₂ or q₃ for Victor Computer). The absolute deviation per million dollars invested is equal to the absolute value of the profit and loss per million dollar invested quantities calculated above. For Kimber Computer, this is depicted in Table 7A, whose median absolute deviation per million dollars invested V for Kimber Computer is determined to be V_{A}=13,004 (i.e., the average of the two median figures 12,180 and 13,827).

TABLE 7A
Absolute Deviations Per Dollar Invested In Kimber Computer (Sorted)
Absolute Value of Daily
Profit Per Million Dollars
Invested (Sorted)

5,147
6,179
10,516
12,180
13,827
14,372
18,674
19,918

For Victor Computer, this is depicted in Table 7B, whose median absolute deviation per million dollars invested is determined to be V_{B}=20,138 (i.e., the average of the two median figures 16,435 and 23,840). The median absolute deviation per million dollars invested V is used as described below.

TABLE 7B
Absolute Deviations Per Dollar Invested In Victor Computer (Sorted)
Absolute Value of Daily
Profit Per Million Dollars
Invested (Sorted)

2,608
3,317
15,411
16,435
23,840
31,739
34,086
55,785

At task 307, the total expected variance per million dollars invested TEV for each state of the portfolio is computed. When the portfolio is in state q₀ (i.e., the portfolio is empty), TEV equals zero. When the portfolio is in state q₁, TEV equals V_{A}=13,004. When the portfolio is in state q₂, TEV equals V_{B}=20,138. And when the portfolio is in state q₃, TEV equals V_{A}+V_{B}=33,142. This is summarized in Table 8 and is used as described below.

TABLE 8
Total Expected Variance Per Million
Dollars Invested for Each State

| Portfolio | |
|---|---|
| State | TEV |
| q₀ | 0 |
| q₁ | 13,004 |
| q₂ | 20,138 |
| q₃ | 33,142 |

At task 308, the daily profit forecast per million dollars invested is calculated, as depicted in Table 9. To compute the average daily profit variance per million dollars, first the total daily profit TDP is computed for each of the twenty days. The total daily profit TDP is the sum of the daily profit per million dollars invested for both Kimber Computer and Victor Computer for each day when the portfolio was not in state q₀. This depicted in column 4 in Table 9.

TABLE 9
Computation of Average Daily Profit Per Dollar of Profit Variance α

| | Portfolio | | | |
|---|---|---|---|---|
| Day | State | TEV | TDP | TDP/TEV |
| 1 | q₀ | — | — | — |
| 2 | q₀ | — | — | — |
| 3 | q₀ | — | — | — |
| 4 | q₁ | 13,004 | (5,147) | (0.39580) |
| 5 | q₂ | 20,138 | 34,086 | 1.69262 |
| 6 | q₂ | 20,138 | (15,411) | (0.76527) |
| 7 | q₂ | 20,138 | 31,739 | 1.57608 |
| 8 | q₂ | 20,138 | 16,435 | 0.81612 |
| 9 | q₂ | 20,138 | 3,317 | 0.16471 |
| 10 | q₂ | 20,138 | (55,785) | (2.77014) |
| 11 | q₁ | 13,004 | 13,827 | 1.06329 |
| 12 | q₁ | 13,004 | 18,674 | 1.43602 |
| 13 | q₁ | 13,004 | 6,179 | 0.47516 |
| 14 | q₁ | 13,004 | (12,180) | (0.93664) |
| 15 | q₀ | — | — | — |
| 16 | q₁ | 13,004 | 19,918 | 1.53168 |
| 17 | q₃ | 33,142 | (7,908) | (0.23861) |
| 18 | q₃ | 33,142 | (38,213) | (1.15301) |
| 19 | q₀ | — | — | — |
| 20 | q₀ | — | — | — |

Second, the ratio of the total daily profit TDP divided by the total expected variance TEV—as calculated above—is computed for each day when the portfolio was not in state q₀. This ratio is depicted in the fifth column in Table 9.

Third and finally, the average daily profit per dollar of variance is calculated as the average of the fourteen ratios for each day when the portfolio was not in state q₀. In this case, the average daily profit per dollar of variance is 0.17830. This is represented as a.

At task 309, the forecasting error β is computed for each day when the portfolio was not in state q₀. This quantity, which for each day is equal to the TDP for that day minus the product of a—as calculated above—and the TEV for that day, is shown in column 6 in Table 10.

TABLE 10
Computation of the Variance Error Terms β

| | Portfolio | | | | |
|---|---|---|---|---|---|
| Day | State | TEV | α * TEV | TDP | β = TDP − (α * TEV) |
| 1 | q₀ | — | — | — | — |
| 2 | q₀ | — | — | — | — |
| 3 | q₀ | — | — | — | — |
| 4 | q₁ | 13,004 | 2,319 | −5,147 | −7,466 |
| 5 | q₂ | 20,138 | 3,591 | 34,086 | 30,495 |
| 6 | q₂ | 20,138 | 3,591 | −15,411 | −19,002 |
| 7 | q₂ | 20,138 | 3,591 | 31,739 | 28,148 |
| 8 | q₂ | 20,138 | 3,591 | 16,435 | 12,844 |
| 9 | q₂ | 20,138 | 3,591 | 3,317 | −274 |
| 10 | q₂ | 20,138 | 3,591 | −55,785 | −59,376 |
| 11 | q₁ | 13,004 | 2,319 | 13,827 | 11,508 |
| 12 | q₁ | 13,004 | 2,319 | 18,674 | 16,355 |
| 13 | q₁ | 13,004 | 2,319 | 6,179 | 3,860 |
| 14 | q₁ | 13,004 | 2,319 | −12,180 | −14,499 |
| 15 | q₀ | — | — | — | — |
| 16 | q₁ | 13,004 | 2,319 | 19,918 | 17,599 |
| 17 | q₃ | 33,142 | 5,909 | −7,908 | −13,817 |
| 18 | q₃ | 33,142 | 5,909 | −38,213 | −44,122 |
| 19 | q₀ | — | — | — | — |
| 20 | q₀ | — | — | — | — |

At task 310, the forecasting error term per million dollars invested β are sorted into bins for all states except state q₀. This is depicted in Table 11.

TABLE 11
Variance Error Terms Sorted by State

| Bin β(q₁) | Bin β(q₂) | Bin β(q₃) |
|---|---|---|
| (14,499) | (59,376) | (44,122) |
| (7,466) | (19,002) | (13,817) |
| 3,860 | (274) | |
| 11,508 | 12,844 | |
| 16,355 | 28,148 | |
| 17,599 | 30,495 | |

Because there were six days in Table 10 in which the portfolio was in state q₁, there are six forecasting error terms sorted into the β(q₁) bin. Similarly, because there were six days in Table 10 in which the portfolio was in state q₂, there are six forecasting error terms sorted into the β(q₂) bin. And because there were only two days in Table 10 in which the portfolio was in state q₃, there are only two forecasting error terms sorted into the β(q₃) bin.

At this point, the daily profit for an investment in accordance with the algorithmic investment strategy can be predicted using equation 17:

R=N*α+β(q)+I (Eq. 17)

where R equals the expected daily profit, N equals the total expected variance of the portfolio when it is in state q, a equals the average daily profit per dollar of variance, β(q) equals a randomly selected forecasting error term from bin q in Table 11 given that the portfolio is in state q, and I is the interest earned on cash not invested in either Kimber Computer or Victor Computer.

At task 311, the candidate performance metric P_{c} is computed as the average of many trials of a Markov chain having states q₀, q₁, q₂, and q₃ and the transition probabilities depicted in Table 6. For each trial of the Markov chain, the chain is transited through 252 transitions so that the candidate performance metric P_{c} equals expected annual return based on the algorithmic investment strategy.

In accordance with the algorithmic investment strategy, when the Markov chain is in state q₀, there is no investment and the predicted daily profit for that day is solely from interest earned on cash not invested, as shown in Equation 18.

R=I (Eq. 18)

When the Markov chain is in state q₁, there is a $1 million investment in Kimber Computer and the predicted daily profit for that day equals:

R=13,004*α+β(q)+I (Eq. 19)

where 13,004 is the expected variance as computed in step 306, and β(q₁) equals a randomly drawn forecasting error term from Bin β(q₁).

When the Markov chain is in state q₂, there is a $1 million investment in Victor Computer and the predicted daily profit for that day equals:

R=20,138*α+β(q₂)+I (Eq. 20)

where 20,138 is the expected variance as computed in step 306, and β(q₂) equals a randomly drawn forecasting error term from Bin β(q₂).

When the Markov chain is in state q₃, there is a $1 million investment in Kimber Computer and a $1 million investment in Victor Computer and the predicted daily profit for that day equals:

R=(13,004+20,138)*α+β(q₃)+I (Eq. 21)

where β(q₃) equals a randomly drawn forecasting error term from Bin β(q₃).

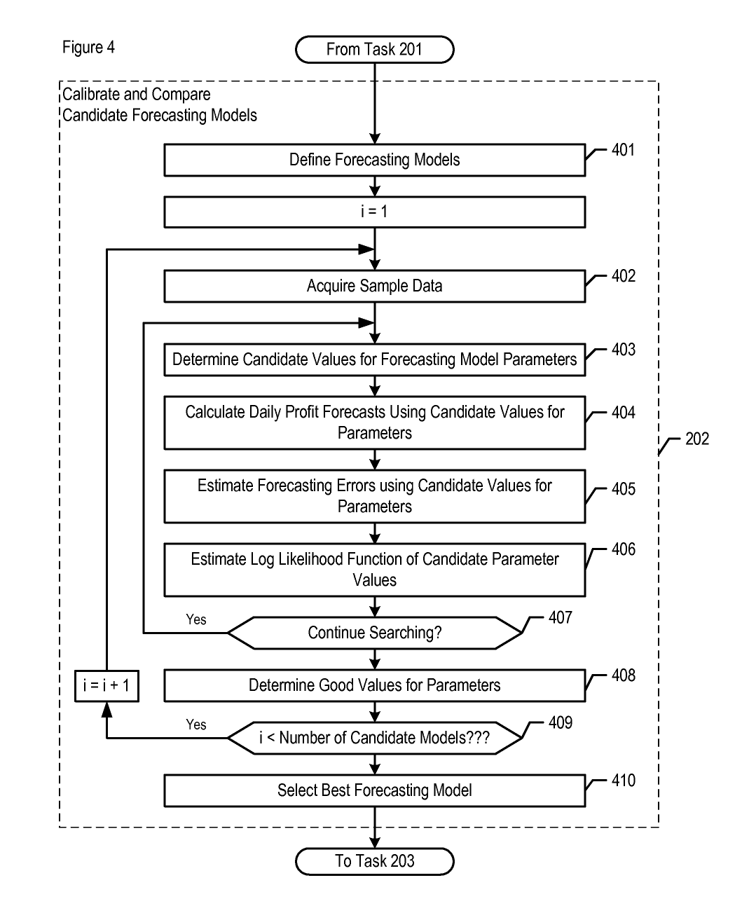

FIG. 4 depicts a flowchart of the salient tasks comprising task 202 in which forecasting model parameters are fitted and forecasting models are compared.

At task 401, a second candidate forecasting model is proposed as an alternative to the model described by equation 17. In this second candidate model, the state of the portfolio is specified by a vector (q, r), where q is defined as in Table 3 above, and r is equal to the percentage change in the Euro/dollar foreign-exchange rate on the previous day. In this illustrative embodiment, the daily profit for an investment in accordance with the algorithmic investment strategy can be predicted using equation 22:

R=N*+α*r+β(q,r)+I (Eq. 22)

where R equals the expected daily profit, N equals the total expected variance of the portfolio when it is in state (q, r), a equals the average daily profit per dollar of variance, and I is the interest earned on cash not invested in either Kimber Computer or Victor Computer. k is a parameter of the forecasting model. The best value to assign to k is determined at task 408 below. β(q, r) is a randomly selected forecasting error term given that the portfolio is in state (q, r). Because the r component of the portfolio state is a continuous variable, the number of possible portfolio states in this embodiment of the invention is potentially very large, and the likelihood of frequently observing any particular state is correspondingly low. Therefore, β is computed by sorting the forecasting errors into bins containing instances of similar states. In this embodiment of the invention, “similar” states are states having the same q component. It will be clear to those skilled in the art, after reading this disclosure, how to aggregate similar states for any algorithmic investment strategy and any historical data.

At task 402, historical price data for Kimber Computer, Victor Computer and the Euro/dollar foreign-exchange rate are acquired. For pedagogical purposes this illustrative embodiment uses twenty (20) days worth of daily closing prices, as depicted in Table 12, but it will be clear to those skilled in the art how to make and use alternative embodiments of the present invention that use any amount of historical data. This illustrative embodiment uses daily closing prices, but it will be clear to those skilled in the art, after reading this disclosure, how to make and use alternative embodiments of the present invention that use other data (e.g., volume data, opening price data, up-tick data, down-tick data, inter-market data, etc.) for any period (e.g., per hour, per minute, per tick, etc.). As will be clear to those skilled in the art, the more historical data that is available and used, the better.

TABLE 12
Twenty Days of Daily Market Data

| | Kimber | Victor | |
|---|---|---|---|
| | Computer | Computer | |
| | Share | Share | Euro/Dollar |
| | Closing | Closing | Exchange |
| Day | Price | Price | Rate |
| 1 | 91.55 | 21.28 | 1.4126 |
| 2 | 93.05 | 22.17 | 1.4137 |
| 3 | 93.06 | 22.09 | 1.4158 |
| 4 | 92.78 | 22.59 | 1.4119 |
| 5 | 93.04 | 23.36 | 1.4150 |
| 6 | 91.21 | 23.00 | 1.4232 |
| 7 | 91.55 | 23.73 | 1.4192 |
| 8 | 89.70 | 24.12 | 1.4217 |
| 9 | 90.31 | 24.20 | 1.4183 |
| 10 | 94.02 | 22.85 | 1.4204 |
| 11 | 95.32 | 22.72 | 1.4311 |
| 12 | 97.10 | 22.73 | 1.4311 |
| 13 | 97.70 | 22.61 | 1.4171 |
| 14 | 97.51 | 22.18 | 1.4264 |
| 15 | 97.90 | 22.56 | 1.4269 |
| 16 | 99.85 | 23.01 | 1.4330 |
| 17 | 98.80 | 23.07 | 1.4396 |
| 18 | 97.38 | 22.52 | 1.4435 |
| 19 | 98.01 | 22.68 | 1.4445 |
| 20 | 99.23 | 22.56 | 1.4510 |

At task 403, a candidate value for the parameter k is chosen. In accordance with this illustrative embodiment, k is a real-valued number in the range of −20,000≦k≦20,000. Its best value is estimated in task 408 below. The prescribed range of k is a guesstimate of the maximum range of values for k that can be expected to yield the greatest value of the likelihood function defined in task 406 below. In general, the choice of the range is based on logic, experience, intuition, and one additional consideration. If the upper boundary is too low or the lower boundary is too high, then the value of k that yields the best fit to the historical data might be precluded from consideration. In accordance with this illustrative embodiment, the initial candidate value is chosen as 2,500. In subsequent iterations of task 403, the candidate value of parameter k is updated according to the well-known bisection method.

When the number of model parameters is small, as in this illustrative embodiment, the best parameter value(s) can be found by exhaustively searching the parameter space. Alternatively, when the parameter space is too large to be searched exhaustively, candidate parameter values can be chosen by means of probabilistic search methods, such as the well-known Markov Chain Monte Carlo method. It will be clear to those skilled in the art, after reading this disclosure, how to choose initial parameter values and updating procedures for alternative embodiments of the present invention.

At task 404, daily profit forecasts are calculated using the candidate values for the forecasting model parameters. This is described in detail below and in the accompanying figures.

At task 405, the forecasting error for the candidate forecasting model is computed for each day, based upon the results of task 404. Daily profit forecasts and their corresponding errors are calculated only for those days in which the algorithmic investment strategy indicates that an investment is made. The forecasting errors of the candidate model, using candidate parameter value k=2,500, are presented in Table 13.

TABLE 13
Forecasting Errors with k = 2,500

| Day | Forecast | Actual | Error |
|---|---|---|---|
| 1 | — | — | — |
| 2 | — | — | — |
| 3 | — | — | — |
| 4 | 2690 | (5147) | 7837 |
| 5 | 2902 | 34086 | (31184) |
| 6 | 4140 | (15411) | 19551 |
| 7 | 5039 | 31739 | (26700) |
| 8 | 2888 | 16435 | (13547) |
| 9 | 4031 | 3317 | 714 |
| 10 | 2993 | (55785) | 58778 |
| 11 | 2689 | 13827 | (11138) |
| 12 | 4202 | 18674 | (14472) |
| 13 | 2319 | 6179 | (3860) |
| 14 | (127) | (12180) | 12053 |
| 15 | — | — | — |
| 16 | 2406 | 19918 | (17512) |
| 17 | 6978 | (7908) | 14886 |
| 18 | 7061 | (38213) | 45274 |
| 19 | — | — | — |
| 20 | — | — | — |

At task 406, the well-known likelihood function is estimated for the candidate value of parameter k. For any specific set of model parameters, the likelihood function infers the probability distribution of the possible values of those parameters in light of the observed forecasting errors. In this embodiment of the present invention the likelihood function L is approximated by

L=(n/RSS)^{n/2} (Eq. 23)

where n is the number of observations and RSS is the sum of the squares of the observed forecasting errors.

At task 407, the decision is made whether another candidate value for parameter k should be generated and evaluated. In accordance with this illustrative embodiment of the present invention, when the estimated best value of parameter k converges within ±500, control passes to task 408; otherwise, control passes to task 403.

At task 408, a good value is determined for each model parameter. This determination can be made in many ways, depending upon what method is used to sample the parameter space in task 403 above. In this illustrative embodiment, the value for parameter k is chosen to be k=6,080, which maximizes the likelihood function in task 406.

At task 409, the decision is made whether another candidate forecasting model should be evaluated. In accordance with this illustrative embodiment of the present invention, 2 candidate forecasting models are to be evaluated, and therefore, while i<2, the value of i is incremented and control passes to task 402; Conversely, when i=2, control passes to task 410.

At task 410, the best candidate forecasting model is determined, based upon complexity and accuracy. In this embodiment of the present invention, the candidate forecasting model having the lowest value of the well-known Akaike Information Criterion (AIC) is selected as the best candidate model. The AIC is defined as:

AIC=2*p+n*In(L) (Eq. 24)

where p is the number of fitted parameters of the candidate forecasting model, n is the number of observed forecasting errors, and L is the likelihood function as computed at task 406 above. Inserting the L value obtained when the parameter value k=6,080, as determined at task 406, into Equation 23, the AIC value of the forecasting model described by Equation 22 is AIC=285.6352

Similarly, the AIC value of forecasting model described by Equation 17 is AIC=283.7869.

Therefore, the model described by Equation 17 is determined to be the better model.

Those skilled in the art will appreciate that alternative tests (e.g., the likelihood ratio test or the Bayesian Information Criterion) could also be used to choose among candidate forecasting models.

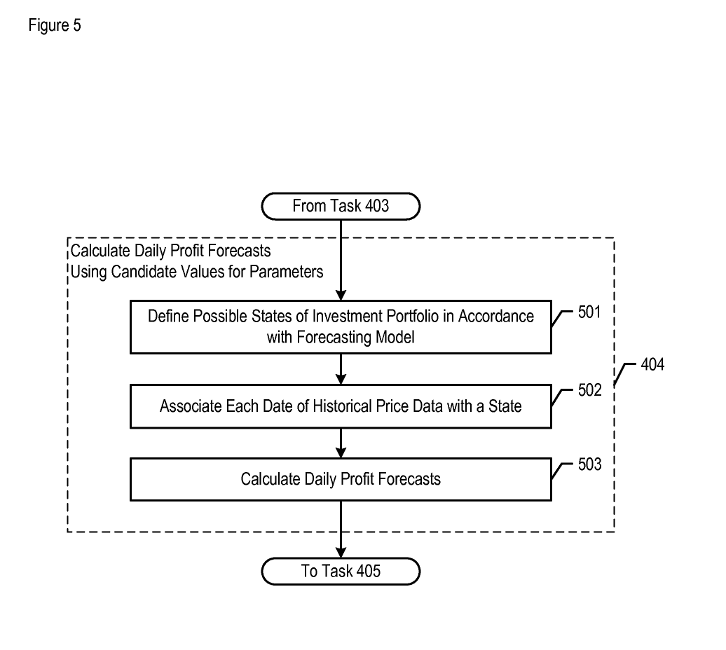

FIG. 5 depicts a flowchart of the salient tasks comprising task 404 in which daily profit forecasts are calculated using the candidate values for the forecasting model parameters.

At task 501, all of the possible states of the investment portfolio in accordance with the candidate forecasting model are defined. In this illustrative embodiment, the state of the investment portfolio is defined by a vector (q, r), where q is defined as in Table 3 above, and r is equal to the percentage change in the Euro/dollar foreign-exchange rate on the previous day. It will be clear to those skilled in the art, after reading this disclosure, how to identify all of the possible states of a portfolio in accordance with any candidate forecasting model.

At task 502, each day of historical data is associated with one of the states enumerated in task 501 based on which investments the algorithmic investment strategy indicated on that day, as well as the previous day's percentage change in the Euro/dollar exchange rate. This is based on the data in Tables 4A, 4B and 12 and is depicted in Table 14.

TABLE 14
States of the Investment Portfolio Using Historical Data,
Algorithmic Investment Strategy, and Forecasting Model
Described by Equation 22

| | | | Percent | |
|---|---|---|---|---|
| | | | Change in | |
| | Investment | Investment | Euro/Dollar | |
| | in Kimber | in Victor | Exchange | Portfolio |
| Day | Computer | Computer | Rate | State |
| 1 | No | No | — | — |
| 2 | No | No | 0.0779 | — |
| 3 | No | No | 0.1485 | (q_{0,}, 0.0779) |
| 4 | Yes | No | −0.2755 | (q_{1,}, 0.1485) |
| 5 | No | Yes | 0.2196 | (q_{2,}, −0.2755) |
| 6 | No | Yes | 0.5795 | (q_{2,}, 0.2196) |
| 7 | No | Yes | −0.2811 | (q_{2,}, 0.5795) |
| 8 | No | Yes | 0.1762 | (q_{2,}, −0.2811) |
| 9 | No | Yes | −0.2392 | (q_{2,}, 0.1762) |
| 10 | No | Yes | 0.1481 | (q_{2,}, −0.2392) |
| 11 | Yes | No | 0.7533 | (q_{1,}, 0.1481) |
| 12 | Yes | No | 0.0000 | (q_{1,}, 0.7533) |
| 13 | Yes | No | −0.9783 | (q_{1,}, 0.0000) |
| 14 | Yes | No | 0.6563 | (q_{1,}, −0.9783) |
| 15 | No | No | 0.0351 | (q_{0,}, 0.6563) |
| 16 | Yes | No | 0.4275 | (q_{1,}, 0.0351) |
| 17 | Yes | Yes | 0.4606 | (q_{3,}, 0.4275) |
| 18 | Yes | Yes | 0.2709 | (q_{3,}, 0.4606) |
| 19 | No | No | 0.0693 | (q_{0,}, 0.2709) |
| 20 | No | No | 0.4500 | (q_{0,}, 0.0693) |

From Tables 4A and 4B, it can be seen that there is no investment in either Kimber Computer or Victor Computer on Days 1, 2, 3, 15, 19, or 20, and, therefore, the first component of the portfolio state vector on those days is q₀. Also it can be seen that there is an investment in Kimber Computer, but not Victor Computer on Days 4, 11, 12, 13, and 14, the first component of the portfolio state vector on those days is q₁. Likewise, there is an investment in Victor Computer, but not Kimber Computer on Days 5 through 10, and, therefore, the first component of the portfolio state vector on those days is q₂. And finally, there is an investment in both Kimber Computer and Victor Computer on Days 17 and 18, and, therefore, the first component of the portfolio state vector on those days is q₃. It will be clear to those skilled in the art, how to associate each period of historical data with a state of the portfolio for any algorithmic investment strategy and any historical data.

At task 503, daily profit forecasts are calculated according to Equation 22, as depicted in Table 14. These results are based upon the data in Tables 8 and 14. In this instance, parameter k has candidate value k=2,500. The constant a was determined at task 308 to have value a=0.17830.

TABLE 15
Daily Forecasts of Portfolio Returns with k = 2,500

| | Portfolio | |
|---|---|---|
| Day | State (q, r) | R = N * α + k * r |
| 1 | — | — |
| 2 | — | — |
| 3 | (q_{0,}, 0.0779) | — |
| 4 | (q_{1,}, 0.1485) | 2,690 |
| 5 | (q_{2,}, −0.2755) | 2,902 |
| 6 | (q_{2,}, 0.2196) | 4,140 |
| 7 | (q_{2,}, 0.5795) | 5,039 |
| 8 | (q_{2,}, −0.2811) | 2,888 |
| 9 | (q_{2,}, 0.1762) | 4,031 |
| 10 | (q_{2,}, −0.2392) | 2,993 |
| 11 | (q_{1,}, 0.1481) | 2,689 |
| 12 | (q_{1,}, 0.7533) | 4,202 |
| 13 | (q_{1,}, 0.0000) | 2,319 |
| 14 | (q_{1,}, −0.9783) | (127) |
| 15 | (q_{0,}, 0.6563) | — |
| 16 | (q_{1,}, 0.0351) | 2,406 |
| 17 | (q_{3,}, 0.4275) | 6,978 |
| 18 | (q_{3,}, 0.4606) | 7,061 |
| 19 | (q_{0,}, 0.2709) | — |
| 20 | (q_{0,}, 0.0693) | — |

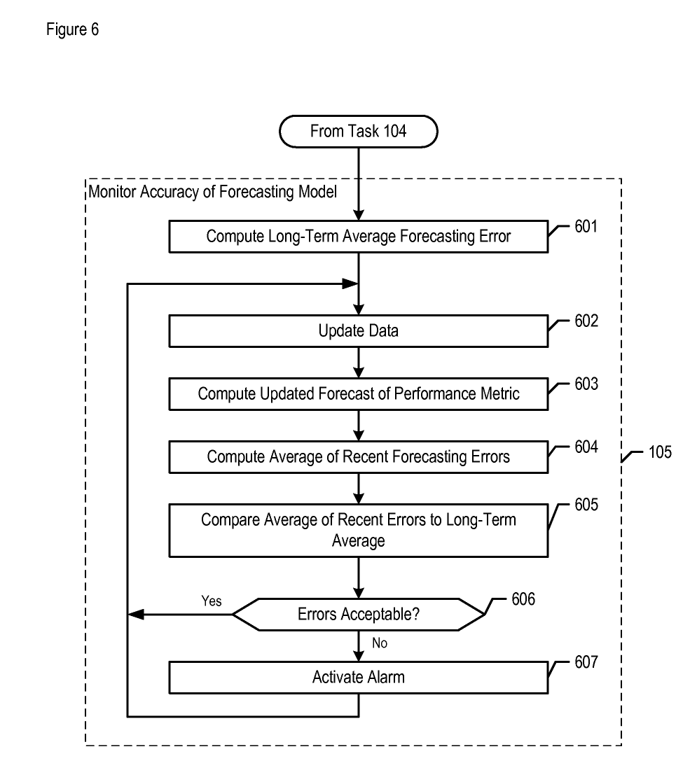

FIG. 6 depicts a flowchart of the salient tasks comprising task 105, in which the accuracy of the forecasting model is monitored. In this illustrative embodiment of the invention, the model is monitored by comparing the average absolute value of the most recently observed forecasting errors versus the long-term average absolute value of forecasting errors. In this embodiment of the invention, task 105 is executed concurrently with task 104.

At task 601, the long-term average absolute value of forecasting errors is computed. Using the error terms from column 6 of Table 10, including only days in which a forecast was produced, the long-term average absolute value of errors is determined to be 19,955, as shown in column 3 of Table 16.

TABLE 16
Computation of Average Forecasting Errors

| | | Absolute | Last |
|---|---|---|---|
| Day | Error | Value | 5 Days |
| 4 | −7,466 | 7,466 | |
| 5 | 30,495 | 30,495 | |
| 6 | −19,002 | 19,002 | |
| 7 | 28,148 | 28,148 | |
| 8 | 12,844 | 12,844 | |
| 9 | −274 | 274 | |
| 10 | −59,376 | 59,376 | |
| 11 | 11,508 | 11,508 | |
| 12 | 16,355 | 16,355 | |
| 13 | 3,860 | 3,860 | 3,860 |
| 14 | −14,499 | 14,499 | 14,499 |
| 16 | 17,599 | 17,599 | 17,599 |
| 17 | −13,817 | 13,817 | 13,817 |
| 18 | −44,122 | 44,122 | 44,122 |
| Average | | 19,955 | 18,779 |

At task 602, any data necessary to produce a forecast of the performance metric is updated. In the illustrative embodiment of the invention, this is accomplished by connecting the forecasting model to a real-time data feed.

At task 603, the forecast of the performance metric is recomputed using the updated values from task 602.

At task 604, the average absolute value of the most recently observed errors is computed. In this embodiment of the invention, the 5 most recent errors from Table 10 are used. As shown in column 4 of Table 16, their average absolute value is determined to be 18,779.

At task 605, the average errors obtained from task 601 and 604 are compared.

At task 606, the determination is made whether or not the recent errors are within an acceptable limit. If so, control passes to task 602; otherwise, control passes to task 607.

At task 607, an alarm is activated, indicating that the recent errors are outside the acceptable limit. Control then passes to task 602.

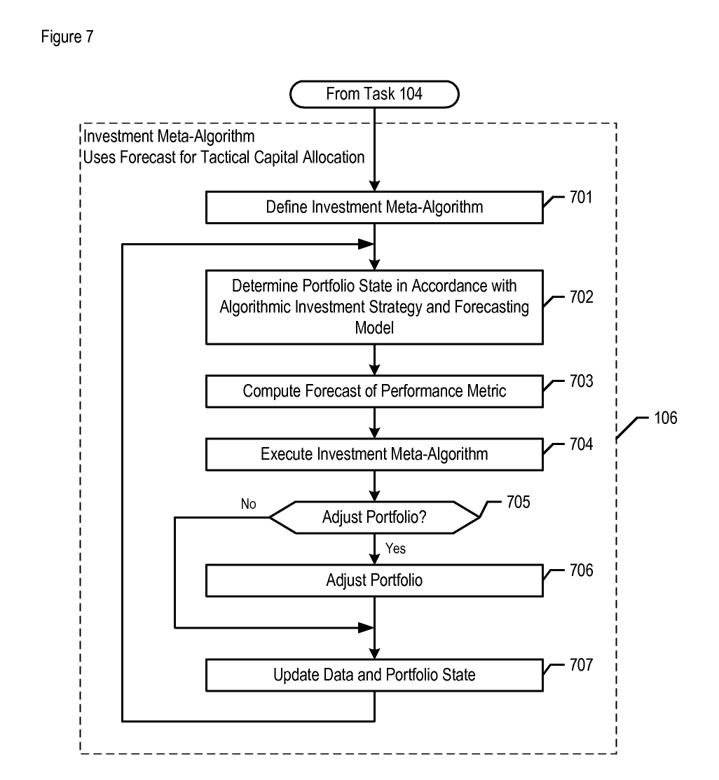

FIG. 7 depicts a flowchart of the salient tasks comprising task 106, in which the outputs of the forecasting model are used in real time by an investment meta-algorithm that allocates capital tactically among a set of investment strategies. In the illustrative embodiment of the invention, task 106 is executed concurrently with task 104.

At task 701, the investment meta-algorithm is defined. In the illustrative embodiment of the present invention, the investment meta-algorithm is characterized by a single allocation rule: the investment meta-algorithm invests in accordance with the algorithmic strategy described in task 104 only on days when the forecasting model (Equation 17) forecasts an expected daily profit greater than $3,000. On the remaining days, the investment meta-algorithm does not invest in accordance with the algorithmic strategy; instead, it invests $1 million in S&P 500 stock index futures.

Although the allocation rule dictates investing exclusively in accordance with one or the other of two available strategies, it will be clear to those skilled in the art, after reading this disclosure, how to make and use alternative embodiments of the present invention that concurrently invest in accordance with more than one strategy. Furthermore, it will be clear to those skilled in the art, after reading this disclosure, how to make and use alternative embodiments of the present invention that invest in accordance with any number of strategies. Moreover, it will be clear to those skilled in the art, after reading this disclosure, how to make and use alternative embodiments of the present invention that make any size investments—or that dictate the sizes of the investments as a function of other factors (e.g., the size of the portfolio, the amount of cash on hand, etc.).

Although the illustrative embodiment of the present invention is conditioned upon the forecast performance of a single algorithmic investment strategy, it will be clear to those skilled in the art, after reading this disclosure, how to make and use alternative embodiments that are conditioned upon the forecast performances of any number of strategies. Furthermore, although the illustrative embodiment is conditioned upon a forecast investment return, it will be clear to those skilled in the art, after reading this disclosure, how to make and use alternative embodiments of the present invention that are conditioned upon any forecast performance metric (e.g., return on capital, probability of catastrophic loss, etc.) or combination of performance metrics.

Although the illustrative embodiment invests in two markets, it will be clear to those skilled in the art, after reading this disclosure, how to make and use alternative embodiments of the present invention that invest in any number of markets. Furthermore, although the illustrative embodiment is taught in the context of markets in common stock and stock index futures contracts, it will be clear to those skilled in the art, after reading this disclosure, how to make and use alternative embodiments of the present invention that invest in any markets. And still furthermore, although the illustrative embodiment only takes long positions in a market, it will be clear to those skilled in the art, after reading this disclosure, how to make and use alternative embodiments of the present invention that take:
i. long positions, or
ii. short positions, or
iii. any combination of long and short positions.

It will also be clear to those skilled in the art, after reading this disclosure, how to make and use alternative embodiments of the present invention in which the investment meta-algorithm comprises any number of rules (e.g., entry rules, exit rules, hedging rules, allocation rules, volatility rules, position rules, etc.) and any number and kind of parameters.

At task 702, the portfolio state is determined in accordance with the algorithmic investment strategy and the forecasting model. This is done in the same manner as in task 304. Note that in the illustrative embodiment, this state does not necessarily reflect the actual composition of the investment portfolio at any given moment. Rather, it reflects what the state of the portfolio would be at that moment if the investment meta-algorithm were fully invested in accordance with the algorithmic strategy. For instance, referring to Table 10, on Day 4 the portfolio state is q₁ for the purpose of forecasting the performance of the algorithmic strategy on that day; however, the investment meta-algorithm would not actually invest in accordance with the algorithmic strategy on that day because the forecast return is only $2,319, which is less than the $3,000 threshold specified in the allocation rule.

At task 703, a forecast is computed based upon the state of the portfolio, as in task 104.

At task 704, the investment meta-algorithm is executed based upon the forecast computed in task 703.

At task 705, a determination is made whether or not the composition of the portfolio needs to be changed in accordance with the allocation rule. If so, control passes to task 706; otherwise, control passes to task 707.

At task 706, the composition of the portfolio is changed in accordance with the allocation rule.

At task 707, all necessary data is updated and control passes to task 702.

It is to be understood that the disclosure teaches just two examples of the illustrative embodiment and that many variations of the invention can easily be devised by those skilled in the art after reading this disclosure and that the scope of the present invention is to be determined by the following claims.

What is claimed is:

1. A method comprising:
defining a performance metric for evaluating the performance of a process for managing the composition of an investment portfolio, wherein the process manages the composition of the investment portfolio according to one or more rules;
applying these rules to sample market data;
calibrating a forecasting model to the resultant data set based on a consideration of the changes of the exposure of the investment portfolio to one or more factors; and
forecasting the performance of the process based on a consideration of the changes of the exposure of the investment portfolio to one or more factors.

2. The method of claim 1 wherein the performance metric is relative to a benchmark.

3. The method of claim 1 wherein forecasting the performance of the process is based on a consideration of the changes of the exposure of the investment portfolio to one or more risk factors.

4. The method of claim 3 wherein the risk factors include the estimated variance of one or more portfolio characteristics versus another quantity or data series.

5. The method of claim 3 further comprising assigning a premium to each risk factor.

6. The method of claim 5 wherein the premium depends on time.

7. The method of claim 1 wherein the performance metric is a probability distribution.

8. The method of claim 1 wherein the performance metric is an investment return.

9. The method of claim 1 wherein the performance metric is goodness of fit to a specified quantity or data series.

10. A method comprising:
generating a plurality of forecasting models for forecasting the performance of an algorithmic investment strategy, wherein each forecasting model is based on a consideration of the changes of the exposure of the investment portfolio to one or more factors;
calibrating each of the plurality of forecasting models to a data set; and
choosing one of the plurality of forecasting models for implementation based on goodness of fit to the data set.

11. The method of claim 10 wherein forecasting the performance of the process is based on a consideration of the changes of the exposure of the investment portfolio to one or more risk factors.

12. The method of claim 11 wherein the risk factors include the estimated variance of one or more portfolio characteristics versus another quantity or data series.

13. The method of claim 11 further comprising assigning a premium to each risk factor.

14. The method of claim 10 wherein the number of parameters of a forecasting model is considered in the estimation of its goodness of fit to the data set.

15. A method comprising:
forecasting the performance of one or more processes for managing the composition of investment portfolios, wherein the processes manage the composition of investment portfolios according to one or more rules and the performance forecasts are based on a consideration of the changes to the exposures of the investment portfolios to one or more factors; and
defining a process for managing the composition of an investment portfolio according to one or more rules, wherein a rule is conditioned upon the value of one or more of these forecasts.

16. The method of claim 15 wherein the forecasts are updated by means of a data feed.

17. The method of claim 15 wherein the performance metric is an investment return.

18. A method comprising:
defining a performance metric for evaluating the performance of a process for managing the composition of an investment portfolio, wherein the process manages the composition of the investment portfolio according to one or more rules;
applying these rules to sample market data;
calibrating a forecasting model to the resultant data set based on a consideration of the changes of the exposure of the investment portfolio to one or more factors;
forecasting the performance of the process based on a consideration of the changes of the exposure of the investment portfolio to one or more factors; and
modifying one or more of the rules in order to improve the forecast value of the performance metric.

19. A method comprising:
defining a performance metric for evaluating the performance of a process for managing the composition of an investment portfolio, wherein the process manages the composition of the investment portfolio according to one or more rules;
forecasting the performance of the process based on a consideration of the changes of the exposure of the investment portfolio to one or more factors;
calculating the differences between a set of forecast values of the performance metric and a set of corresponding observed values of the performance metric; and
comparing these differences with the differences calculated for the most recent forecast values of the performance metric.

20. The method of claim 19 wherein the forecast values and observed values are updated by means of a data feed.
